(19) United States
(12) Patent Application Publication
(10) Pub. No.: US 2005/0190654 A1
(43) Pub. Date: Sep. 1, 2005

(54) Single day alarm clock

(76) Inventor: Niranjan Patel, Edison, NJ (US)

Correspondence Address: Mr. Aziz M. Ahsan, P.O. Box 251, Hopewell Junction, NY, 12533, US

(21) Appl. No.: 10/789,096

(22) Filed: Feb. 27, 2004

(51) Int. Cl. G04C 21/00; G04B 23/02

(52) U.S. Cl. 368/73

(57) ABSTRACT

The present invention relates to a single day alarm clock. More particularly, the invention encompasses a single day alarm clock that can be used in the motel/hotel industry. This invention further includes inventive features, such as, a single touch alarm activation and deactivation feature, flashing light when the alarm is activated, a “night-light” to indicate setting-up of the alarm, a visual reset alarm button to indicate and prevent the undesired activation of the alarm, to name a few.

### FIELD OF THE INVENTION

The present invention relates to a single day alarm clock. More particularly, the invention encompasses a single day alarm clock that can be used in the motel/hotel industry. This invention further includes inventive features, such as, a single touch alarm activation and deactivation feature, flashing light when the alarm is activated, a “night-light” to indicate setting-up of the alarm, a visual reset alarm button to indicate and prevent the undesired activation of the alarm, to name a few.

### BACKGROUND INFORMATION

There are many types of clocks in the market-place. Most popular among them include combination radio and clock, commonly referred to as clock-radios. These clock-radios typically are designed for operation with two different sources of energy, one of which could be a conventional alternating current and the other based on direct current. The clock-radio may also utilize conventional alternating current which is converted into direct current by a transformer, and during emergencies or due to lack of the alternating current, by direct current supplied by one or more batteries, such as, for example, replaceable, rechargeable or non-rechargeable batteries.

According to U.S. Pat. No. 4,187,468 (Kao), the disclosure of which is incorporated herein by reference, many consumer oriented electronic clock radios essentially consist of three integrated circuits (IC's): a radio, a clock, and an electronic digital display. An AC-to-DC voltage regulator, which provides the correct bias voltages to the IC's may or may not be included as an integrated device. The remaining circuitry in the clock radio consists of IC interconnections and interface components.

U.S. Pat. No. 5,402,396 (Jones, Jr.), the disclosure of which is incorporated herein by reference, relates generally to alarm clocks, such as, the radio-alarm clock, where a sleep button is provided in addition to an alarm ON/OFF button, and where such a device is provided with a night-light which enables the above-mentioned control buttons to be illuminated when the alarm is on.

It is also common for such clock-radios to include other various features, such as, for example, “sleep” function, “snooze” function, “nap” function, to name a few. These functions are typically initiated by a switch which activates the radio or a buzzer for a selected time interval, usually 1 to 60 minutes. At the end of this time period the radio or buzzer, either automatically or manually turns off.

Another standard feature of such clock-radios is the “wake-up” alarm which automatically turns the radio on or activates a buzzer when the displayed time and a preselected time setting coincide. Associated with the “wake-up” alarm feature is the “nap” or “snooze” function. Once the “alarm” circuit has turned the radio on, the “snooze” switch can shut the radio off for some standard time interval—usually 9 to 10 minutes. The intended purpose of the “snooze” function is to allow the user to sleep or rest for a short interval after the alarm has sounded or after the radio has been activated.

It is well know for these types of clock-radios to include a cabinet or housing designed for mounting on a wall or resting on a flat surface, etc. and to have an indicator, which is typically next to the time display, indicating the setting of the alarm.

However, one of the problems which exists with the present clocks and clock-radios is that once the alarm has been set, the alarm is automatically activated at the set time unless the user remembers to set it at another time or deactivate the set alarm. For example, for a business traveler checking into a room may not want to be woken up by an alarm set by a person who may have set the alarm the previous night or the traveler may be too tired and wants to wake up naturally after a good nights sleep or the traveler may have other reasons to wake up at a time other than the alarm set on the clock, radio-clock or TV-clock. In most of the hotels/motels this problem is handles by the room cleaning crew who is supposed to deactivate the alarm while cleaning the room, but sometimes they forget. Similarly, this problem arises in a home setting when a person has set an alarm, for example, for the work day, i.e., Monday through Friday, and ends up being woken up at the same time on an off day, for example, Saturday.

Thus, it is clear that the clocks and clock-radios of the prior art have a problem that needs an inventive solution. Furthermore, the present day alarm clocks do not have a button that clearly and visually indicates the activation or deactivation on the alarm, thus there is a need for such a device. Similarly, the present day alarm clocks do not have a button that clearly and visually indicates the activation of the alarm, thus there is a need for such a device. These and other innovative features are contemplated by this invention.

Purposes and Summary of the Invention

The invention is a single day and/or a single touch alarm clock.

Therefore, one purpose of this invention is to provide an alarm clock with a clear visual button when the alarm has been set on the clock.

Another purpose of this invention is to provide a flashing light upon the activation of the set alarm.

Yet another purpose of this invention is to provide a visual reset alarm button to indicate and prevent the undesired activation of the alarm.

Therefore, in one aspect this invention comprises an apparatus, comprising an alarm-clock, wherein said alarm-clock has at least one button and at least one alarm, and wherein when said alarm is set said alarm button radiates light.

In another aspect this invention comprises an apparatus, comprising an alarm-clock, wherein said alarm-clock has at least one button and at least one alarm, and wherein when said alarm is activated said alarm button radiates a flashing light.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, however, both as to organization and method of operation, may best be understood by reference to the detailed description which follows taken in conjunction with the accompanying drawings in which:

FIG. 1A is a first embodiment of the invention showing the inventive single day alarm clock.

FIG. 1B is a cutaway view along section 1A-1A from FIG. 1A showing the alarm button in an inactive position.

FIG. 1C is a cutaway view along section 1A-1A from FIG. 1A showing the alarm button in an active position.

FIG. 2 is second embodiment of the invention showing the inventive single day alarm clock with at least one associated electronic component.

### DETAILED DESCRIPTION

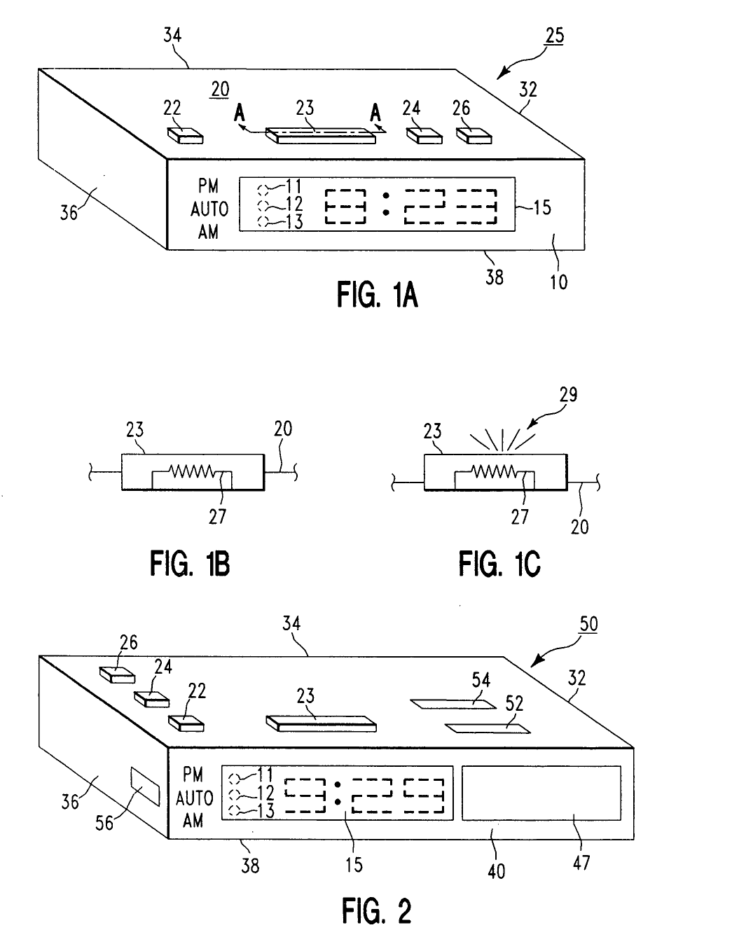

FIG. 1A is a first embodiment of the invention showing the inventive one-touch, single-day alarm clock 25, having a first or face surface 10, a second or top surface 20, a third or side surface 32, a fourth or back surface 34, a fifth or side surface 36, and a sixth or bottom surface 38. The face of the alarm clock 25 has a display area 15 for displaying features, such as, for example, time, alarm time activation or deactivation of the clock or alarm setting, to name a few. The display area 15 could have one or more indicators 11, 12, or 13. The face surface 10 can also have additional features, such as, for example, AM, PM, AUTO, indicators or signs. Under normal use the display area 15 indicates the current time of day or night in the display window 15, but the display area 15 could also have other informational indicators, such as, for example, an AM or PM indicator, alarm ON or OFF indicator, to name a few. Typically, the alarm-clock 25 has other buttons, knobs or features to operate the alarm-clock, such as, for example, time setting button, alarm setting button, hour and minute setting buttons, intensity button for the digital display 15, snooze button, different buzzer or alarm sound buttons, to name a few. These buttons can be placed on any of the surface of the alarm-clock, but for the ease of understanding these buttons are placed on top surface 20 of the alarm-clock 25, and these buttons are indicated by numerals 22,24 and 26. It would be within the realm of a person skilled in the art to assign each of these buttons to do a specific task or to be able to share one or more of the desired tasks. These buttons 22, 24 and 26, could be activated by any of the well known methods, such as, off-on, toggle, rotation, to name a few. The alarm clock 25 has been shown with a digital feature in the display area 15, however, one could also have an analog clock (not shown).

Under normal conditions, the alarm-clock 25 is energized by a source of alternating current (AC) power, such as ordinary household current. The AC power is supplied to the present invention 25 via a power supply cord (not shown), when the power supply cord is connected to an AC source in the usual manner.

FIG. 1B is a cutaway view along section 1A-1A from FIG. 1A showing the alarm button 23 having a luminescent device 27 in an inactive or first position. The luminescent device 27, could be selected from a group consisting of an incandescent bulb, a fluorescent bulb, a sodium bulb, a halogen bulb, an LED, an LCD, to name a few. The housing for the alarm button 23 is preferably of a material that makes the alarm button 23 visible in the dark. These material could be selected from a group consisting of opaque material, transparent material, translucent material, iridescent material, to name a few. An optional button could be associated with the luminescent device 27 for controlling the illumination.

Figure 1C is a cutaway view along section 1A-1A from FIG. 1A showing the alarm button 23 in an active or second position showing the bulb 27 radiating light 29. For the purposes of this invention the bulb 27 radiates light 29 during one of two events. The bulb 27 radiates light 29 when the alarm is set and so that the alarm-clock 25 provides a visual reminder to anyone looking at the alarm-clock 25 that the alarm has been set. The second event that triggers the radiation of the light 29 from the bulb 27 is when the set alarm has been activated, during this event it is preferred to show the light 29 as a flashing light 29. It would be within the realm of a person skilled in the art to provide a light dimming feature to the bulb 29, so that it could be used as a night-light or the intensity of the bulb 27 could be reduced as desired to maintain or provide darkness to the environment where this alarm-clock 25 is placed.

The buttons 22,23,24 and 26 have been shown in FIG. 1A as being raised above the top surface 20, however, these buttons could be flush-mounted, be below the top surface 20, or these buttons could be touch-sensitive membrane type buttons. Additionally, the single-touch buttons allow the activation and deactivation of the button, for example, the activation of the alarm button 23 and the subsequent deactivation of the same alarm button 23 with a single touch. As stated earlier, the activation of the alarm button with a single-touch sets up the alarm button 23, and it radiates light 29, and the subsequent touching of the alarm button 23 deactivates the alarm set-up button 23, and the transmission of light 29 is stopped.

There could be one or more internal or external speakers associated with the alarm-clock 25. A multiple alarm set-up feature could also be provided with the alarm-clock 25, such as, a dual alarm set-up feature which allows a first person to set an alarm for a first time and a second person to set an alarm on the same alarm-clock 25 for a second time, and where the second alarm set-up time may be the same or different than the first alarm set-up time.

It should also be appreciated that portion of the electronic clock 25, in FIG. 1A, and many of the other normal circuit interconnections have not been shown, since their presence and operation are not relevant to this invention.

FIG. 2 is second embodiment of the invention showing the inventive single day alarm-clock 50 with at least one associated electronic component 47 on a first or front face 40. The electronic component 47 could be selected from a group consisting of a second alarm-clock, an AM-FM radio, a SW-MW radio, a CB radio, a weather channel radio, a cassette tape player and/or recorder, a TV, a VCR, a CD, a DVD, a PDA, a computer, a telephone, a mobile phone, an MP3 player, to name a few. The electronic component 47 could be a fixed or a permanent component of the alarm-clock 50 or it could be an extractable self-contained electronic component 47, which when extracted would leave an opening (not shown) in the face 40. Buttons 52,54 and 56, as shown in FIG. 2, maybe provided with the alarm-clock 50. These buttons along with buttons 22, 24 and 26, could be used to operated the alarm-clock 50 and/or the electronic component 47. The buttons could also be used to as a radio band selector, radio tuner, station indicator, radio signal output adjustment for power and volume control or for station selection.

The alarm-clock 25 and/or 50 could also be provided with a battery back-up (not shown) or a connection to an alternating current (not shown).

The present invention also relates generally to a self-contained, portable, combination television receiver (TV), AM/FM radio receiver, clock, night-light with a one-touch alarm set and reset. The combination can be powered by either a source of ordinary household alternating current or by a direct current source, such as, for example, a battery pack or motor vehicle battery. The nigh-light may be provided with a dimmer switch, and an alarm is associated with the clock. More particularly, the invention encompasses an alarm radio/clock for use in a hotel/motel room. The invention further includes a flashing light which is activated with the alarm.

Optionally, a battery-powered hand held remote control device (not shown) could also be provided with this invention so that the user can control any or all functions and features of the various components of the invention 25 or 50. Upon the user's direction, the remote control device could issue a signal, such as, an infrared signal detectable by the respective and various remote control sensors associated with the clock-alarm 25 or 50 in order to control any or all of the functions of the invention 25 or 50. In the alternative, if the user so chooses, each component and/or feature of the apparatus 25 or 50, can also be controlled manual by their respective control buttons.

Some of the typical features that are assigned to buttons or knobs 22,24,26,52,54 and 56 are: speaker volume control, band selector, device tuning control, minute set-up, hour set-up, snooze, sleep, time set-up, alarm set-up ON/OFF., LED display control, dial scale, function switch, back light control, night-light control, alarm volume control, alarm selector (for example, between a buzzer and an electronic component 47), to name a few. As stated earlier that one could assign each feature to each button or allow the sharing of features among the various buttons.

It is preferred that the alarm-clock 25 or 50 operates using 120 V-60 Hz household type current, but it could be supplied with a battery, such as a 9 Volt type battery, as a back-up or as a main source. Similarly, the alarm-clock 25 or 50 could be made to operate using a different voltage and frequency, such as, for example, 220 V-50 Hz. If a battery back-up is provided then the clock time and alarm setting can be protected in the event of a power failure. In that event the clock time and the alarm settings could be held in memory, and when the power interruption has ended all the settings and features would appear, and normal operation could continue.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. An apparatus, comprising an alarm-clock, wherein said alarm-clock has at least one button and at least one alarm, and wherein when said alarm is set said alarm button radiates light.

2. The apparatus of claim 1, wherein at least one luminescent device is associated with said alarm button, and wherein said luminescent device is selected from a group consisting of an incandescent bulb, a fluorescent bulb, a sodium bulb, a halogen bulb, an LED, and an LCD.

3. The apparatus of claim 1, wherein material for said alarm button is selected from a group consisting of opaque material, transparent material, translucent material and iridescent material.

4. The apparatus of claim 1, wherein at least one electronic component is associated with said alarm-clock, and wherein said electronic component is selected from a group consisting of a second alarm-clock, an AM-FM radio, a SW-MW radio, a CB radio, a weather channel radio, a cassette tape player and/or recorder, a TV, a VCR, a CD, a DVD, a PDA, a computer, a telephone, a mobile phone and an MP3 player.

5. The apparatus of claim 1, wherein said alarm-clock is operated using an alternating current or a directed current.

6. The apparatus of claim 1, wherein said at least one button is selected from a group consisting of a button that protrudes from the alarm-clock housing, a button that is flush with the alarm-clock housing, a button that is below the alarm-clock housing and a button that is a touch-sensitive membrane.

7. The apparatus of claim 1, wherein said alarm-clock is powered by a power source selected from a group consisting of an alternating current source between about 120 volts and about 240volts, and a direct current source between about 1 volt and about 24 volts.

8. The apparatus of claim 1, wherein the display of said alarm-clock is selected from a group consisting of a digital display and an analog display.

9. The apparatus of claim 1, wherein at least one means is provided to control light radiating from said alarm-clock.

10. An apparatus, comprising an alarm-clock, wherein said alarm-clock has at least one button and at least one alarm, and wherein when said alarm is activated said alarm button radiates a flashing light.

11. The apparatus of claim 10, wherein at least one luminescent device is associated with said alarm button, and wherein said luminescent device is selected from a group consisting of an incandescent bulb, a fluorescent bulb, a sodium bulb, a halogen bulb, an LED, and an LCD.

12. The apparatus of claim 10, wherein material for said alarm button is selected from a group consisting of opaque material, transparent material, translucent material and iridescent material.

13. The apparatus of claim 10, wherein at least one electronic component is associated with said alarm-clock, and wherein said electronic component is selected from a group consisting of a second alarm-clock, an AM-FM radio, a SW-MW radio, a CB radio, a weather channel radio, a cassette tape player and/or recorder, a TV, a VCR, a CD, a DVD, a PDA, a computer, a telephone, a mobile phone and an MP3 player.

14. The apparatus of claim 10, wherein said alarm-clock is operated using an alternating current or a directed current.

15. The apparatus of claim 10, wherein said at least one button is selected from a group consisting of a button that protrudes from the alarm-clock housing, a button that is flush with the alarm-clock housing, a button that is below the alarm-clock housing and a button that is a touch-sensitive membrane.

16. The apparatus of claim 10, wherein said alarm-clock is powered by a power source selected from a group consisting of an alternating current source between about 120 volts and about 240 volts, and a direct current source between about 1 volt and about 24 volts.

17. The apparatus of claim 10, wherein the display of said alarm-clock is selected from a group consisting of a digital display and an analog display.

18. The apparatus of claim 10, wherein at least one means is provided to control light radiating from said alarm-clock.
